(19) United States
(12) Patent Application Publication
(10) Pub. No.: US 2006/0019813 A1
(43) Pub. Date: Jan. 26, 2006

(54) Sealing glass composition, sealing glass frit, and sealing glass sheet

(75) Inventor: Tetsuro Yoshii, Tsukuba-shi (JP)

Correspondence Address: COHEN, PONTANI, LIEBERMAN & PAVANE, 551 FIFTH AVENUE, SUITE 1210, NEW YORK, NY, 10176, US

(73) Assignee: Nippon Sheet Glass Company, Limited, Tokyo (JP)

(21) Appl. No.: 11/187,478

(22) Filed: Jul. 22, 2005

(30) Foreign Application Priority Data
Jul. 23, 2004 (JP) 2004-215955
Jul. 8, 2005 (JP) 2005-200597

(51) Int. Cl. C03C 8/24; C03C 3/091; C03C 3/093; C03C 3/095; C03C 3/064; C03C 3/068; C03C 3/072

(52) U.S. Cl. 501/15; 501/66; 501/67; 501/77; 501/75; 501/78; 501/64

(57) ABSTRACT

A sealing glass composition which has an alkali metal oxide content kept down as much as possible, and can stably join metal or ceramic members together in a temperature range of 600 to 900° C. The sealing glass composition is used to join together members each selected from the group consisting of metal members and ceramic members, and comprises, as essential components, 20 to 50 mol % of SiO₂, 1 to 9 mol % of Al₂O₃, 5 to 25 mol % of B₂O₃, 10 to 40 mol % of BaO, and 5 to 20 mol % of SrO. ZnO content is 0 to 10 mol %. An alkali metal oxide content is not more than 5 mol %. PbO is substantially not contained. The total content of MgO, CaO, SrO, BaO and ZnO is 30 to 50 mol %.

### BACKGROUND OF THE INVENTION

1. Field of the Invention

The present invention relates to a sealing glass composition, a sealing glass frit, and a sealing glass sheet, and in particular relates to a sealing glass composition, a sealing glass frit, and a sealing glass sheet for a solid oxide fuel cell (SOFC) used in a temperature range of 600 to 900° C.

2. Description of the Related Art

In the manufacture of composites composed of ceramic and/or metal members, sealing glass compositions are widely used as a joining material for joining the members together to form the composite. Such a sealing glass composition may be processed into a glass powder and thus used as a sealing glass frit, or may be processed into a sheet and thus used as a sealing glass sheet. Either a sealing glass frit or a sealing glass sheet is suitable for use in the case of sealing together flat surfaces, whereas a sealing glass frit is the more suitable in the case of sealing up a three-dimensional cavity.

A known method of manufacturing a sealing glass frit is comprised of first mixing a plurality of kinds of inorganic materials together so as to obtain a mixture having a composition suitable for the intended use, melting the mixture at a high temperature so as to make the composition ratio uniform, then cooling the mixture to obtain a glass composition, pulverizing the glass composition obtained to form a glass powder, and mixing in the glass composition additives such as a filler (a filler containing inorganic crystals) as required.

Known methods of manufacturing a sealing glass sheet include a method comprised of obtaining a glass composition having a predetermined composition as in the above method of manufacturing a sealing glass frit, and then processing the glass composition into a sheet having a predetermined thickness and shape by heating or cutting, and a method comprised of first forming a frit, and then mixing in the frit a binder or the like and processing into a sheet. A filler may be added to the glass composition in this case.

Moreover, a known method of manufacturing a composite for the case using a sealing glass frit is comprised of making a sealing glass frit obtained as described above into, for example, a paste, then applying the sealing glass frit onto a ceramic member, softening the sealing glass frit at a high temperature so as to fusion-bond the sealing glass frit to the ceramic member, joining a metal member to the ceramic member via the fusion-bonded sealing glass frit, and cooling the members joined together via the sealing glass frit to obtain the composite.

Typical sealing glass frits that have been known from hitherto include ones based on B₂O₃ or P₂O₅ that can be used in a low-temperature range below 600° C., and ones using a glass ceramics that can be used in a high-temperature range of not less than 1000° C.

Further, in recent years, there has been an increase in demand for sealing glass compositions that be used for high-temperature equipment such as solid oxide fuel cells for which the operating temperature is approximately 700 to 900° C. In particular, in the case of use in a solid oxide fuel cell, a sealing glass composition must remain air-tight and mechanically and chemically stable at such an operating temperature, and moreover the expansion ratio of the sealing glass composition from room temperature to the operating temperature must be approximately the same as the expansion ratio of the fusion-bonded members. Sealing glass compositions that satisfy these requirements are known (see, for example, Japanese Laid-open Patent Publication (Kokai) No. 2000-63146, Japanese Patent Application No. 2000-294052, and the pamphlet of International Laid-open Patent Publication No. 04/31088). The standard for the expansion ratio of such sealing glass compositions is an average value from room temperature to around the operating temperature (generally not less than 600° C.) of not less than 100×10⁻⁷/° C. Such sealing glass compositions thus contain alkali metal oxides to increase the expansion ratio.

However, solid oxide fuel cells are operated at temperatures of not less than 700° C., and hence if the sealing glass composition contains alkali metal oxides which contain monovalent ions that readily undergo thermal diffusion, then the monovalent ions will diffuse into the fusion-bonded ceramic or metal members through thermal diffusion, causing a marked deterioration of the properties of the solid oxide fuel cell.

### SUMMARY OF THE INVENTION

It is an object of the present invention to provide a sealing glass composition, a sealing glass frit, and a sealing glass sheet, which have an alkali metal oxide content kept down as much as possible, and can stably join metal or ceramic members together in a temperature range of 600 to 900° C.

To attain the above object, in a first aspect of the present invention, there is provided a sealing glass composition for joining together members each selected from the group consisting of metal members and ceramic members, the sealing glass composition comprising, as essential components, 20 to 50 mol % of SiO₂, 1 to 9 mol % of Al₂O₃, 5 to 25 mol % of B₂O₃, 10 to 40 mol % of BaO, and 5 to 20 mol % of SrO, wherein ZnO content is 0 to 10 mol %, an alkali metal oxide content is not more than 5 mol %, PbO is substantially not contained, and a total content of MgO, CaO, SrO, BaO and ZnO is 30 to 50 mol %.

According to this composition, the alkali metal oxide content can be kept down as much as possible, and metal or ceramic members can be stably joined together in a temperature range of 600 to 900° C.

Preferably, the sealing glass composition contains 1 to 10 mol % of a broadly defined rare earth oxide.

According to this composition, devitrification during fusion-bonding can be suppressed, and a viscosity giving sufficient sealing ability at the operating temperature (700 to 900° C.) of a solid oxide fuel cell or the like comprised of the sealing glass composition can be obtained.

More preferably, the sealing glass composition contains 1 to 9 mol % of Y₂O₃.

According to this composition, a yield point of not less than 680° C. can be obtained while suppressing devitrification.

Preferably, the sealing glass composition has an alkali metal oxide content of not more than 0.5 mol %.

According to this composition, deterioration of the properties of the ceramic or metal can be prevented.

Preferably, the sealing glass composition contains not more than 3.5 mass % of CoO.

According to this composition, the ability to join to ceramic or metal members can be improved.

To attain the above object, in a second aspect of the present invention, there is provided a sealing glass frit which comprises the sealing glass composition according to the first aspect of the present invention.

According to this composition, the alkali metal oxide content can be kept down as much as possible, and metal or ceramic members can be stably joined together in a temperature range of 600 to 900° C.

Preferably, the sealing glass frit contains 0.1 to 10 mass % of at least one filler selected from the group consisting of alumina, cordierite, silica, zircon, aluminum titanate, forsterite, mullite, β-eucryptite, and β-spodumene.

According to this composition, the expansion ratio of the sealing glass frit can be suitably adjusted.

To attain the above object, in a third aspect of the present invention, there is provided a sealing glass sheet which comprises the sealing glass composition according to the first aspect of the present invention.

According to this composition, the alkali metal oxide content can be kept down as much as possible, and metal or ceramic members can be stably joined together in a temperature range of 600 to 900° C.

Preferably, the members joined together by the sealing glass composition are component elements of a solid oxide fuel cell.

According to this composition, the service life of the solid oxide fuel cell can be increased.

The above and other objects, features, and advantages of the invention will become more apparent from the following detailed description taken in conjunction with the accompanying drawings.

### BRIEF DESCRIPTION OF THE DRAWINGS

FIG. 1 is a schematic view showing component elements of a solid oxide fuel cell joined together by a sealing glass composition according to an embodiment of the present invention; and

FIG. 2 is a perspective view showing a stainless steel substrate and a ring used for evaluating the fusion-bonding ability of a sealing glass frit.

### DETAILED DESCRIPTION OF THE PREFERRED EMBODIMENTS

The present inventors carried out assiduous studies to attain the above object, and as a result discovered that if a sealing glass composition for joining together members each selected from the group consisting of metal members and ceramic members is comprised of, as essential components, 20 to 50 mol % of SiO₂, 1 to 9 mol % of Al₂O₃, 5 to 25 mol % of B₂O₃, 10 to 40 mol % of BaO, and 5 to 20 mol % of SrO, wherein ZnO content is 0 to 10 mol %, an alkali metal oxide content is not more than 5 mol %, PbO is substantially not contained, and a total content of MgO, CaO, SrO, BaO and ZnO is 30 to 50 mol %, then the sealing glass composition has an alkali metal oxide content kept down as much as possible, and can stably join metal or ceramic members together in a temperature range of 600 to 900° C.

A description will now be given of the functions of the essential components of the sealing glass composition.

SiO₂ is a main component of the sealing glass composition. If the SiO₂ content is less than 20 mol %, then vitrification will not occur, whereas if the SiO₂ content is more than 50 mol % and at the same time the alkali metal oxide content is not more than 5 mol %, then it will not be possible to carry out fusion-bonding sufficiently even at a temperature of 1100° C.

Al₂O₃ is an essential component for suppressing devitrification at around the operating temperature (700 to 900° C.) of a solid oxide fuel cell or the like. If the Al₂O₃ content is less than 1 mol %, then this effect will not be observed, whereas if the Al₂O₃ content is more than 9 mol %, then devitrification will be liable to occur during fusion-bonding.

B₂O₃ is an essential component for suppressing devitrification at around the operating temperature (700 to 900° C.) of a solid oxide fuel cell or the like. If the B₂O₃ content is less than 5 mol %, then this effect will not be observed, whereas if the B₂O₃ content is more than 25 mol %, then the viscosity around the fusion-bonding temperature will drop markedly.

BaO is an essential component for obtaining a predetermined expansion ratio. If the BaO content is less than 20 mol %, then it will not be possible to obtain the predetermined expansion ratio, whereas if the BaO content is more than 40 mol %, then devitrification will be liable to occur at around 800° C.

SrO is an essential component for obtaining a predetermined expansion ratio. If the SrO content is 5 to 20 mol %, then the expansion ratio can be increased.

If not more than 10 mol % of ZnO is added to the glass comprised of the above essential components, then devitrification when molten can be prevented. If MgO and CaO are added such that the total content of MgO, CaO, SrO, BaO and ZnO is not more than 50 mol %, then the viscosity and the expansion ratio can be suitably adjusted.

The present inventors further discovered that if the glass comprised of the above essential components contains 1 to 10 mol % of a broadly defined rare earth oxide, then devitrification during fusion-bonding can be suppressed, and moreover a viscosity giving sufficient sealing ability at the operating temperature (700 to 900° C.) of a solid oxide fuel cell or the like can be obtained; preferably, the glass contains 1 to 9 mol % of Y₂O₃, whereby a yield point of not less than 680° C. can be obtained while suppressing devitrification. If, however, the glass contains more than 10 mol % of the broadly defined rare earth oxide, then devitrification will become liable to occur. “Broadly defined rare earth oxide” means a lanthanide oxide, Sc₂O₃, or Y₂O₃.

The present inventors also discovered that if the glass comprised of the above essential components has not more than 3.5 mass % of CoO added thereto, then the ability to join to ceramic or metal members can be improved. If, however, the amount of CoO added is more than 3.5 mass %, then devitrification will become liable to occur during fusion-bonding. Moreover, although CoO is effective as a transition metal oxide for improving the joining ability, the present inventors discovered that such the joining ability effectively can also be improved with oxides of V, Cr, Mn, Fe, Ni, Cu, Nb, Mo, Ta, Bi, or a lanthanoid-type transition metal oxide depending on the types of the ceramic or metal members to be fusion-bonded together.

Alkali metal oxides are used as components for adjusting the expansion ratio, but if alkali metal oxides, which contain monovalent ions that readily undergo thermal diffusion, are contained in the sealing glass composition, then the monovalent ions will diffuse into the fusion-bonded ceramic or metal members through thermal diffusion, causing a marked deterioration of the properties of the ceramic or metal. It is thus preferable to keep the alkali metal oxide content down as much as possible, i.e. to keep the total content of Li₂O, Na₂O and K₂O down to not more than 5 mol %, preferably not more than 0.5 mol %, in accordance with the use. As a result, deterioration of the properties of the ceramic or metal can be prevented.

The above sealing glass composition may be processed into a sealing glass frit, or may be processed into a sealing glass sheet. Moreover, 0.1 to 10 mass % of at least one filler selected from the group consisting of alumina, cordierite, silica, zircon, aluminum titanate, forsterite, mullite, β-eucryptite, and β-spodumene may be added. As a result, the expansion ratio of the sealing glass frit can be suitably adjusted.

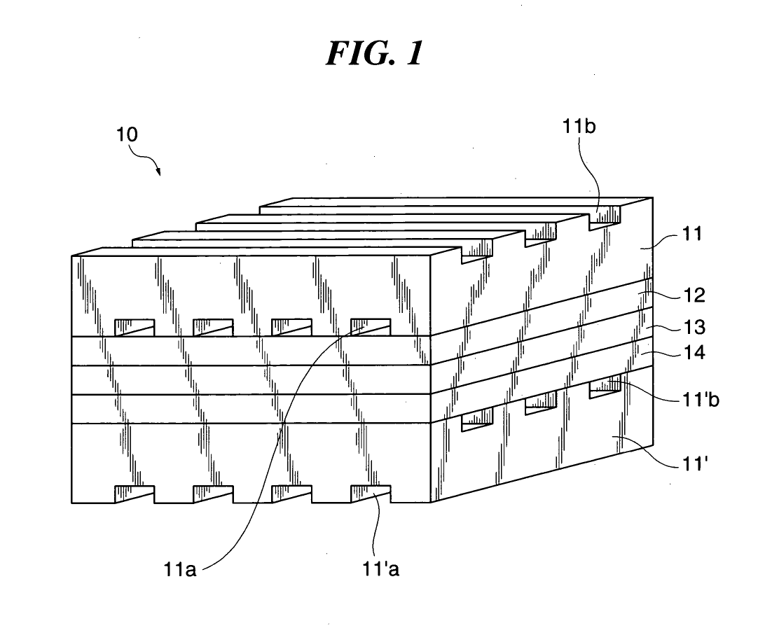

Moreover, the present inventors discovered that if the members joined together by the above sealing glass composition are, for example, component elements of a solid oxide fuel cell as shown in FIG. 1, described below, then the service life of the solid oxide fuel cell can be increased.

FIG. 1 is a schematic view showing component elements of a solid oxide fuel cell joined together by a sealing glass composition according to an embodiment of the present invention.

As shown in FIG. 1, the solid oxide fuel cell 10 is comprised of separators 11, 11′ made of a Ni—Cr alloy, a cathode 12 made of (La,Sr)MnO₃, an electrolyte 13 made of YSZ(yttria-stabilized zirconia), and an anode 14 made of a YSZ/Ni cermet.

The separator 11 (11′) has formed therein an air distributing layer 11a (11′a) for supplying O₂ to the cathode 12, and a fuel distributing layer 11b (11′b) for supplying H₂, CO, CH₄, or the like to the anode 14.

The separator 11 is joined to the cathode 12, and the anode 14 to the separator 11′, respectively, by a sealing glass composition as described above. When the electrolyte 13 is heated to an operating temperature of, for example, not less than 700° C., the electrolyte 13 exhibits ionic conductivity to serve as an electrolyte. Moreover, the cathode 12 and the anode 14 are connected together by an electric wire, not shown.

In the solid oxide fuel cell 10 described above, H₂, CO, CH₄, or the like that passes through the fuel distributing layer 11b (11′b), and O²⁻ that passes through the electrolyte 13 and is thus supplied to the anode 14 undergo an oxidation reaction on the surface of the anode 14, thus producing H₂O and/or CO₂. At this time, electrons are liberated and migrate to the anode 14. The electrons that have migrated to the anode 14 are transmitted as electricity to the cathode 12 via the electric wire connecting the cathode 12 to the anode 14.

On the other hand, O₂ that passes through the air distributing layer 11a (11′a) undergoes a reduction reaction on the surface of the cathode 12, thus producing O²⁻. The O²⁻ passes through the electrolyte 13 and is thus supplied to the anode 14.

As described above, during operation, the solid oxide fuel cell 10 is normally heated to an operating temperature of not less than 700° C. so as to cause the electrolyte 13 to exhibit ionic conductivity. As a result, if the sealing glass composition contains alkali metal oxides which contain monovalent ions that readily undergo thermal diffusion, then the monovalent ions will diffuse into the fusion-bonded ceramic or metal members through thermal diffusion, causing a marked deterioration of the properties of the solid oxide fuel cell 10. This is a reason why a sealing glass composition as described above that has an alkali metal oxide content kept down as much as possible and can stably join metal or ceramic members together in a temperature range of 600 to 900° C. is used to join the metal or ceramic members together.

According to the above embodiment of the present invention, a sealing glass composition comprised of glass having a composition as described above is used to join the separator 11 to the cathode 12 and the anode 14 to the separator 11′, in the solid oxide fuel cell 10. As a result, the service life of the solid oxide fuel cell 10 can be increased.

It is to be understood that that the sealing glass composition of the present invention is not limited to being used in such a solid oxide fuel cell 10, but rather may be used for any use in which it is required to be able to stably join metal or ceramic members together at a temperature of up to 1000° C., and to stably maintain the state of sealing between the metal or ceramic members at a temperature of up to 750° C.

### EXAMPLES

Examples of the present invention will now be described.

Raw materials were mixed together to give each composition shown in Table 1 in amounts such that the total weight of the molten glass would be 300 g, and the mixture was melted in a platinum crucible at 1400° C. for 4 hours. The melt was then cast into a stainless steel mold, held at 650° C. for 2 hours, and then cooled down to room temperature at 5° C./minute.

TABLE 1

| | | | | | | | | | | | | | Comparative | |
|---|---|---|---|---|---|---|---|---|---|---|---|---|---|---|
| | Examples | | | | | | | | | | | | Examples | |
| | 1 | 2 | 3 | 4 | 5 | 6 | 7 | 8 | 9 | 10 | 11 | 12 | 1 | 2 |
| SiO₂(mol %) | 30 | 28 | 29.5 | 30 | 28.3 | 34 | 29.7 | 29.5 | 50 | 45 | 45 | 45 | 66.2 | 64 |
| Al₂O₃(mol %) | 5 | 4 | 4.9 | 5 | 4.7 | 3 | 4.9 | 4.9 | 3.4 | 3.5 | 3.5 | 3.5 | 1.4 | 8 |
| B₂O₃(mol %) | 15 | 20 | 14.7 | 15 | 14.2 | 12 | 14.9 | 10.7 | 9 | 8 | 6 | 6 | | |
| Na₂O(mol %) | | | | | | | | | | | | | 8.3 | 4 |
| K₂O(mol %) | | 2 | | | | | | | | | | | 8.3 | 4 |
| MgO(mol %) | | | 0.2 | | | | | | | 1 | | | | 5 |
| CaO(mol %) | | | | | | | | | | 1 | | | | |
| SrO(mol %) | 15 | 14 | 14.7 | 15 | 14.2 | 14 | 14.9 | 14.8 | 10.1 | 12 | 13.4 | 13.3 | | 5 |
| BaO(mol %) | 30 | 28 | 29.5 | 30 | 28.4 | 28 | 29.8 | 29.5 | 20.1 | 24.1 | 26.7 | 26.5 | | |
| ZnO(mol %) | 5 | 4 | 4.9 | | 4.7 | 4 | | 4.9 | 3.4 | 3.4 | 3.4 | 1.7 | 15.8 | 10 |
| La₂O₃(mol %) | | | 1.6 | | | | | | | | | | | |
| Y₂O₃(mol %) | | | | 5 | 5.5 | 5 | 5.8 | 5.7 | 4 | 2 | 2 | 4 | | |
| CoO(mass %) | | | | 1 | | | | | | | | | | |
| RO(mol %)* | 50 | 46 | 49.3 | 45 | 47.3 | 46 | 44.7 | 49.2 | 33.6 | 41.5 | 43.5 | 41.5 | 15.8 | 20 |
| Average Expansion Ratio from | 109 | 112 | 107.6 | 106 | 106 | 101 | 106 | 104 | 82 | 94 | 103 | 97 | 105.2 | 65.3 |
| 50 to 350° C.(×10⁻⁷/° C.) | | | | | | | | | | | | | | |
| Average Expansion Ratio from | | | 118 | 114 | 112 | 106 | 115 | 110 | 87 | 99 | 109 | 102 | — | 76 |
| 50 to 600° C.(×10⁻⁷/° C.) | | | | | | | | | | | | | | |
| Yield Point(° C.) | 628 | 605 | 641 | 691 | 700 | 701 | 702 | 737 | 744 | 717 | 727 | 756 | 614 | 734 |
| Glass Transition | 579 | 550 | 589 | 630 | 635 | 648 | 654 | 672 | 689 | 660 | 671 | 700 | 562 | 685 |
| Temperature(° C.) | | | | | | | | | | | | | | |
| Ability to Fusion-Bond to Metal | Δ | Δ | Δ | ◯ | ◯ | ◯ | ◯ | ◯ | ◯ | ◯ | ◯ | ◯ | ◯ | X |
| (950° C.) | | | | | | | | | | | | | | |
| Ability to Fusion-Bond to | Δ | Δ | ◯ | ◯ | ◯ | ◯ | ◯ | ◯ | ◯ | ◯ | ◯ | ◯ | ◯ | X |
| Ceramic(950° C.) | | | | | | | | | | | | | | |
| Thermal Stability at 800° C. | ◯ | ◯ | ◯ | ◯ | ◯ | ◯ | ◯ | ◯ | ◯ | ◯ | ◯ | ◯ | X | X |

*RO = MgO + CaO + SrO + BaO + ZnO

Using glass blocks of Examples 1 to 12 and Comparative Examples 1 and 2 prepared as described above, the expansion ratio, the glass transition point, the yield point, the ability to fusion-bond to metal members and ceramic members, and the thermal stability at 800° C. were evaluated.

The expansion ratio, the glass transition point, and the yield point were measured as follows.

A part of each of the prepared glass blocks was processed into a cylinder of diameter 5 mm and length 15 mm, thus producing a sample for measuring the expansion ratio, the glass transition point, and the yield point. A “TAS-100” thermal analysis system (TMA) made by Rigaku Co., Ltd. was used for the measurements. The measurement temperature range was made to be from room temperature up to a temperature around the yield point, and the heating rate was set to 5° C./minute.

The ability to fusion-bond to metal was evaluated as follows.

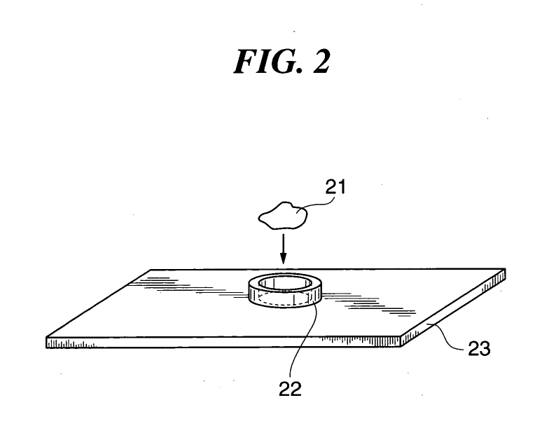

Another part of each of the above glass blocks was pulverized in a mortar to produce, as a sealing glass frit 21, a powder having a particle diameter controlled to 10 to 20 μm. Approximately 5 g of the sealing glass frit 21 was placed on a watch glass, and made into a paste by adding methanol. An appropriate amount of the paste was then packed to a height of 1 to 2 mm into a ring 22 of diameter 10 mm which had been placed on a stainless steel substrate 23 of thickness 1 mm and length and width 30 mm, and then dried. After the paste had sufficiently dried, the ring 22 was taken off, thus obtaining a sample for a fusion-bonding test (FIG. 2). While still on the stainless steel substrate 23, the sample was heated to a temperature of 950° C. at a heating rate of 100° C./hour, held at 950° C. for 1 hour, and then cooled down to room temperature at 100° C./hour. After that, it was checked whether or not the sample was fusion-bonded to the stainless steel substrate 23. Specifically, if after cooling down to room temperature the sample had not separated away from the stainless steel substrate 23 at all, then the sample was evaluated to be “excellent” (“◯”); if the sample had partially separated away, then the sample was evaluated to be “good” (“Δ”); and if the sample had completely separated away, then the sample was evaluated to be “no good” (“X”).

Moreover, the evaluation of the ability to fusion-bond to ceramic members was carried out using the same method as described above, except that the stainless steel substrate 23 was changed over to a ceramic substrate made of zirconia (“KZ-8” made by Kyoritsu Elex Co., Ltd.).

The thermal stability at 800° C. was evaluated as follows.

A cubic block of side approximately 5 mm was cut out from each of the glass blocks described above, thus producing a sample for evaluating the thermal stability. Each sample was placed on a stainless steel substrate, and put into an electric furnace, and then heated from room temperature to approximately 800° C. at a heating rate of 100° C./hour, held at 800° C. for 48 hours, and then cooled down to room temperature at 100° C./hour. If after cooling down to room temperature the sample had not undergone deformation or devitrification at all, then the sample was evaluated to be “excellent” (“◯”); if deformation or devitrification was observed in part of the sample, then the sample was evaluated to be “good” (“Δ”); and if the whole of the sample had undergone deformation or devitrification, then the sample was evaluated to be “no good” (“X”).

The evaluation results for the expansion ratio, the glass transition point, the yield point, the ability to fusion-bond to metal members and ceramic members, and the thermal stability at 800° C. are shown in Table 1.

For Comparative Examples 1 and 2, a reason that the thermal stability at 800° C. is poor is that if B₂O₃ is not contained, then devitrification becomes liable to occur around the operating temperature (700 to 900° C.).

For Comparative Example 2, a reason that the fusion-bonding ability to each of metal members and ceramic members is poor is that the SiO₂ content is high at 64 mol % and at the same time the alkali metal oxide content is not more than 5 mol %.

The following was ascertained from the results for Examples 1 to 12 and Comparative Examples 1 and 2 shown in Table 1.

If the glass has, as essential components, 20 to 50 mol % of SiO₂, 1 to 9 mol % of Al₂O₃, 5 to 25 mol % of B₂O₃, 10 to 40 mol % of BaO, and 5 to 20 mol % of SrO, ZnO content is 0 to 10 mol %, the alkali metal oxide content is not more than 5 mol %, PbO is substantially not contained, and the total content of MgO, CaO, SrO, BaO and ZnO is 30 to 50 mol %, then the yield point temperature can be made to be not less than 600° C.; the sealing glass composition thus has an alkali metal oxide content kept down as much as possible, and can stably join metal or ceramic members together in a temperature range of 600 to 900° C.

Moreover, if 1 to 10 mol % of a broadly defined rare earth oxide is contained in the glass containing the above essential components, then the yield point temperature can be made to be not less than 640° C.; devitrification during fusion-bonding can thus be suppressed, and moreover a viscosity giving sufficient sealing ability at the operating temperature of (700 to 900° C.) a solid oxide fuel cell or the like can be obtained. Preferably, if the glass contains 1 to 9 mol % of Y₂O₃, then the yield point can be made to be not less than 680° C., and the glass transition point can be made to be not less than 600° C.; a yield point of not less than 680° C. can thus be obtained while suppressing devitrification.

The sealing glass composition according to the present invention hardly contains alkali metal oxides. As a result, deterioration of the properties of metal or ceramic members caused by diffusion of monovalent ions does not occur, and the sealing glass composition can join together metal or ceramic members in a solid oxide fuel cell, and hence can be suitably used as a sealant for a solid oxide fuel cell.

What is claimed is:

1. A sealing glass composition for joining together members each selected from the group consisting of metal members and ceramic members, the sealing glass composition comprising, as essential components, 20 to 50 mol % of SiO₂, 1 to 9 mol % of Al₂O₃, 5 to 25 mol % of B₂O₃, 10 to 40 mol % of BaO, and 5 to 20 mol % of SrO, wherein ZnO content is 0 to 10 mol %, an alkali metal oxide content is not more than 5 mol %, PbO is substantially not contained, and a total content of MgO, CaO, SrO, BaO and ZnO is 30 to 50 mol %.

2. A sealing glass composition as claimed in claim 1, containing 1 to 10 mol % of a broadly defined rare earth oxide.

3. A sealing glass composition as claimed in claim 2, containing 1 to 9 mol % of Y₂O₃.

4. A sealing glass composition as claimed in claim 1, having an alkali metal oxide content of not more than 0.5 mol %.

5. A sealing glass composition as claimed in claim 1, containing not more than 3.5 mass % of CoO.

6. A sealing glass frit comprising a sealing glass composition as claimed in claim 1.

7. A sealing glass frit as claimed in claim 6, containing 0.1 to 10 mass % of at least one filler selected from the group consisting of alumina, cordierite, silica, zircon, aluminum titanate, forsterite, mullite, β-eucryptite, and β-spodumene.

8. A sealing glass sheet comprising a sealing glass composition as claimed in claim 1.

9. A sealing glass composition as claimed in claim 1, wherein the members joined together by the sealing glass composition are component elements of a solid oxide fuel cell.
